(19) United States
(12) Patent Application Publication
(10) Pub. No.: US 2022/0085703 A1
(43) Pub. Date: Mar. 17, 2022

(54) THE METHOD OF WINDING CONSTRUCTION IN A LINEAR MOTOR

(71) Applicant: Nevomo Poland sp. z o. o., Warszawa (PL)

(72) Inventors: Tomasz KUBLIN, Warsaw (PL); Lukasz ORDYSZEWSKI, IIowo (PL); Jan OLESZCZUK, Kobylka (PL)

(73) Assignee: Nevomo Poland sp. z o. o., Warszawa (PL)

(21) Appl. No.: 17/429,276

(22) PCT Filed: Feb. 6, 2020
(86) PCT No.: PCT/IB2020/050952

§ 371 Date: Aug. 6, 2021

(30) Foreign Application Priority Data
Feb. 7, 2019 (PL) PL428844

(51) Int. Cl. H02K 15/06; H02K 3/47

(52) U.S. Cl. CPC H02K 15/061; H02K 3/47

(57) ABSTRACT

The subject matter of the invention is the method of construction of a linear motor winding, consisting of phase paths, characterised in that a solid flat bar is cyclically bent at a selected binding radius R₁, the active part and the end parts constitute a uniform plane of the phase path, which has got elongated end fragments: the beginning of the section and the end of the section or the phase path is cut of metal sheet, as shown in the figure and then, along the line, separating the end part from the active part, it is bent at the bending radius R₂, where the bend angle α₁ is within the range between 0° and 180°.

The subject matter of the invention is the method of construction of linear motor winding, consisting of solid phase paths.

The method of construction of linear motor lap windings has been known, consisting of copper rods, wound as coils. The meander winding has been known from document No. US20050173993A1, made of an electric wire, laid in slots and fixed with, at least, one tie-wrap. The three-phase wave winding for linear motors has been known from document No. PL221120. This winding is assembled from single rods, cut from a metal sheet with water or a laser beam. The elements, cut in such a way, are merged into full phase paths by welding or pressure welding. The winding of a rotary motor has been known from document No. JP1985234438A, where the phase path is made from a single flat bar, properly bent into a series of coils. The method of construction of a coreless lap winding for a linear motor has been known from document No. US20160233754A1. A method of the layout and merging of a series of pre-assembled coils into a single winding, followed by putting it into a mould and pouring with a thermoplastic material is described therein.

The existing methods of linear motor winding construction are not optimised with regards to the production for high power motors, intended, for example, for transport applications. Such windings are made of large cross-section cables and are therefore characterised by very big bending radii. Bending and laying are time consuming processes, additionally extended by the large winding size. The mass productions of windings for small power linear motors, used in automatics and industry, are widely known. The existing technical solutions, regarding the production of windings for high power linear motors, are expensive in their implementation or their execution lasts too long. In case of high speed transport, an electric linear motor is a better type of drive, when compared to traditional rotary motors. It is a type of direct drive, i.e. a drive which is simple in its structure and reliable. In addition, it has no mechanical contact connections which, at high speeds, above 300 km/h, are in particular susceptible to failures, due to the limited mechanical strength of the components of the drive system. The electric linear motors are used in high speed transport applications at few places around the world only. The main limitation for the mass application of this type of drive is the high cost of railway track construction, where the tracks are, among others, provided with a linear motor stator.

The purpose of the present invention is to speed up the production of linear motor windings and reduce the costs of its technological process.

The following definitions have been used in the description of the method according to the invention.

The solid phase path shall be understood as the phase paths of an electric motor, made of a solid conductor, dia- or paramagnetic (such as, for example, copper, aluminium, superconductors, gold or silver).

The mover shall be understood as the moving part of a linear motor

The stator shall be understood as the stationary part of a linear motor, being also the track on which the mover runs.

Section 3 in FIG. 6 shall be understood as the smallest fragment of the winding, made in accordance with the description of the object of the invention.

The winding shall be understood as the primary part of an electric linear motor, laid out flat along the path of a vehicle's movement and consisting of many single sections.

In case of this solution, the pole pitch shall be understood as the distance between the neighbouring rods of one phase path of the active part.

The vehicle shall be understood as a device which makes use of this solution and is driven by it.

The essential feature of this invention is the method of construction of the linear motor winding which consists of phase paths, the method being characteristic of the cyclic bending of a solid flat bar at a preselected bending radius, where the active part and the end parts constitute a uniform plane of the phase path with elongated end fragments: the beginning of the section and the end of the section or the phase path is cut of metal sheet, according to the figure, and then, the phase path is bent along the line, separating the end part from the active part, at the bending radius, where the angle α₁ is within the range from 0°- to 180°.

Preferably, a solid flat bar or metal sheet is made of a dia- or paramagnetic material.

Preferably, phase paths are laid out parallel and in a non-conflicting way, making a section.

Preferably, the winding of a linear motor is sectioned and consists of many identical sections.

Preferably, subsequent sections are connected with each other by means of screws and then placed in clamping plugs, welded or connected by a system of contactors.

Preferably, the phase path is cut of a metal sheet, either with a laser beam or water or plasma.

Preferably, the winding is made as either single- or double-layer winding.

Preferably, the active part and the end parts are covered with an insulation layer, either by lacquer coating or by pouring a thermoplastic material in a preset mould.

Preferably, the sections are fastened to the surface by means of bolts and/or spring clips and/or latches.

The subject matter of the invention is the method of construction of a solid phase path 2 from a properly bent single flat bar or from an element, cut off from a metal sheet 5, as shown in FIG. 5, and then of laying it out flat and connection with subsequent paths in a winding structure, as shown in FIG. 6.

This invention has been discussed in detail in examples and demonstrated in figures, where

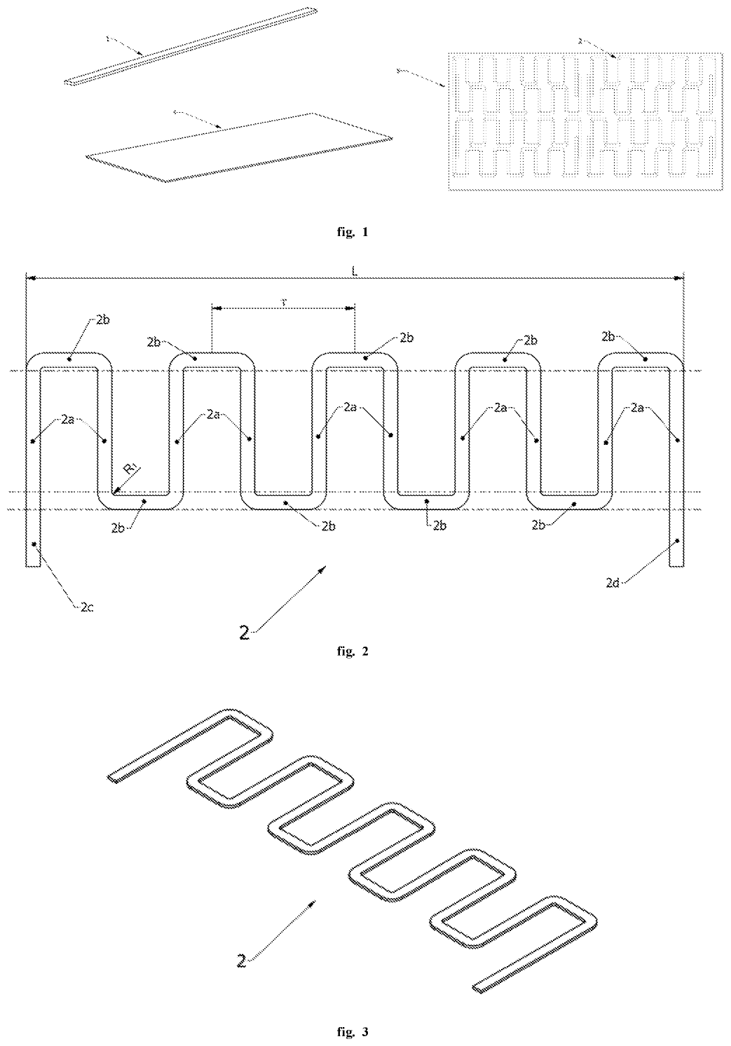

FIG. 1 shows semi-finished (intermediate) products, out of which, the winding is further made, according to the description of the invention: a flat bar 1 and a metal sheet 5. Also demonstrated is an example pattern of cutting of several phase paths 2 from a metal sheet.

FIG. 2 shows a single phase path 2, consisting of active parts 2a, end parts 2b and of the beginning of section 2c and of the end of section 2d. Also marked is the pole pitch r, the bending radius R₁ and the phase path length L.

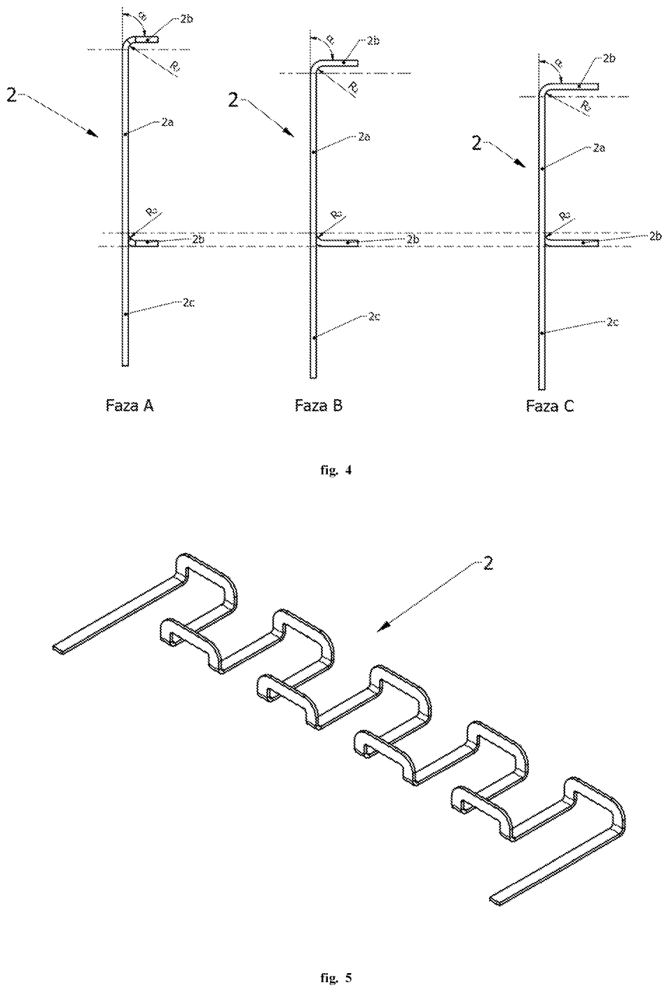

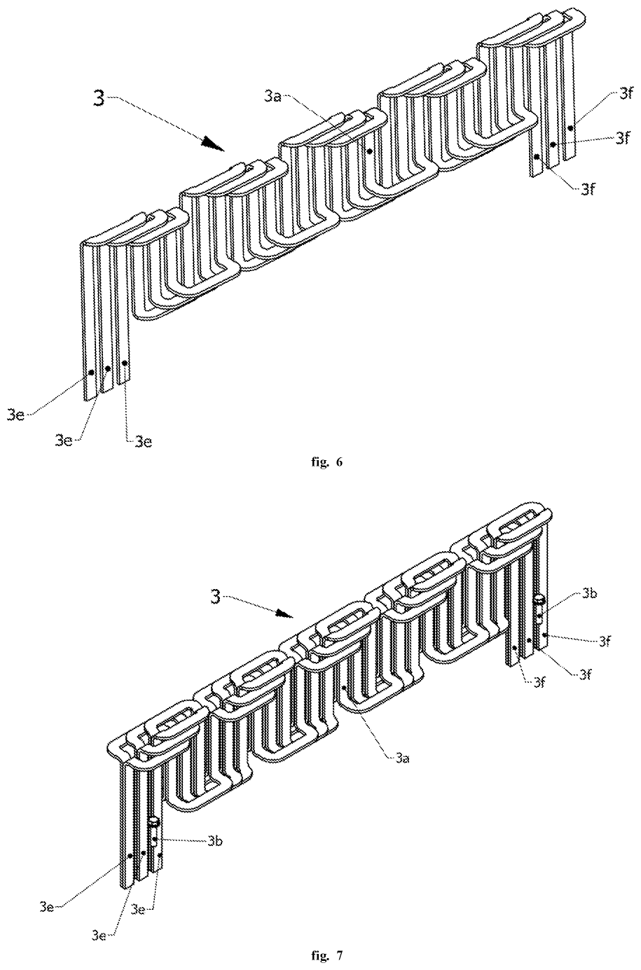

FIG. 3 shows a phase path 2 in isometric projection FIG. 4 shows the cross-sections of bent phase paths in the following three versions: Phase A, Phase B, Phase C. The active part and the end parts have different heights for each version. The bending radii (R₂) and the bend angle (α₁) are also marked.

FIG. 5 shows a bent phase path in isometric projection.

FIG. 6 shows 3 phase paths 2 in each version, combined in one section of the winding 3a in the single-sided system. The following elements are indicated: the terminals of the beginning of the section 3e and of the end of the section 3f.

FIG. 7 shows a three-phase winding in the double-sided system. In addition, the fastening screws are shown.

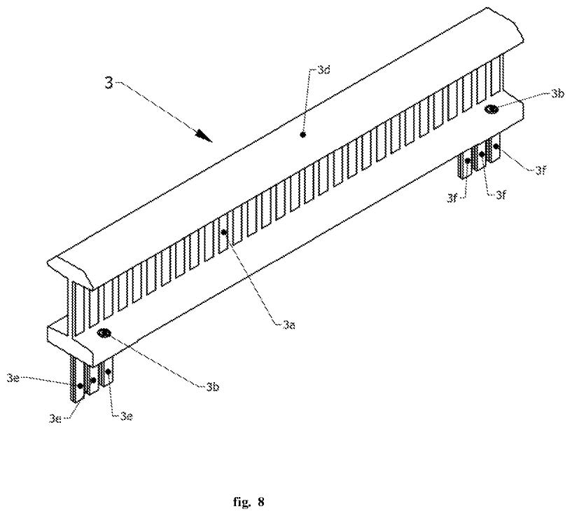

FIG. 8 shows a three-phase winding, presented in FIG. 7 after its pouring with a thermoplastic material 3d.

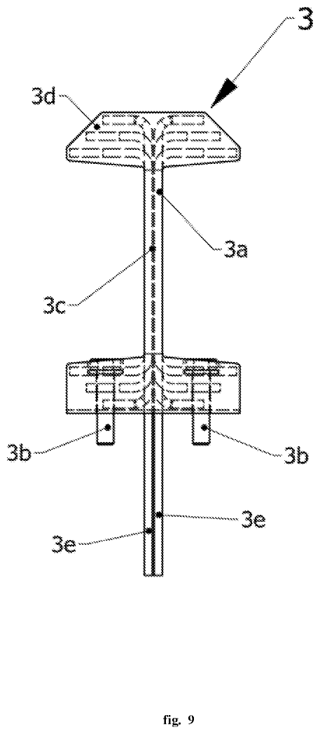

FIG. 9 shows the cross-section of the structure presented in FIG. 8. The separator 3c is marked; it is used in the double-sided system and protects against short circuit of the right and left side of the winding.

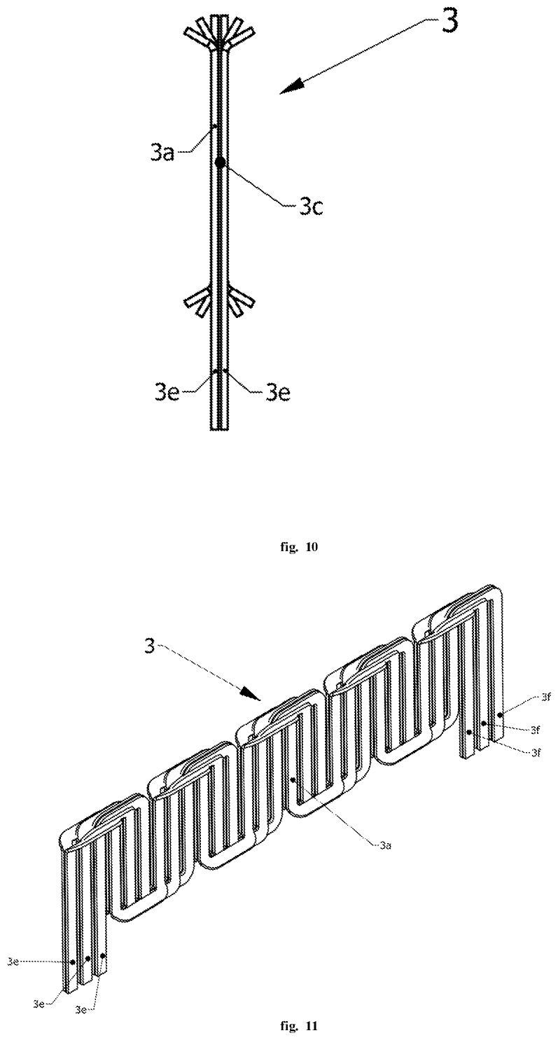

FIG. 10 shows a three-phase winding in the double-sided system, similarly as in FIG. 9, however, at different bend angles α₁ than in FIG. 9.

FIG. 11 shows a three-phase winding from the picture of FIG. 10 in isometric projection.

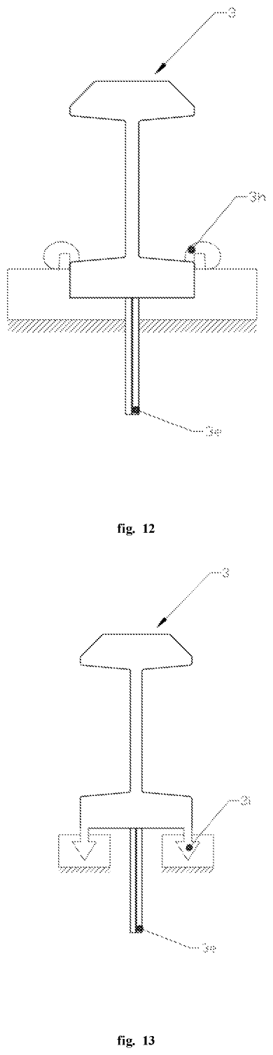

FIG. 12 shows a fastening method—by means of spring clips 3h—of a winding poured with a thermoplastic material 3d.

FIG. 13 shows a fastening method with spring clips 3i of the winding, poured with a thermoplastic material 3d.

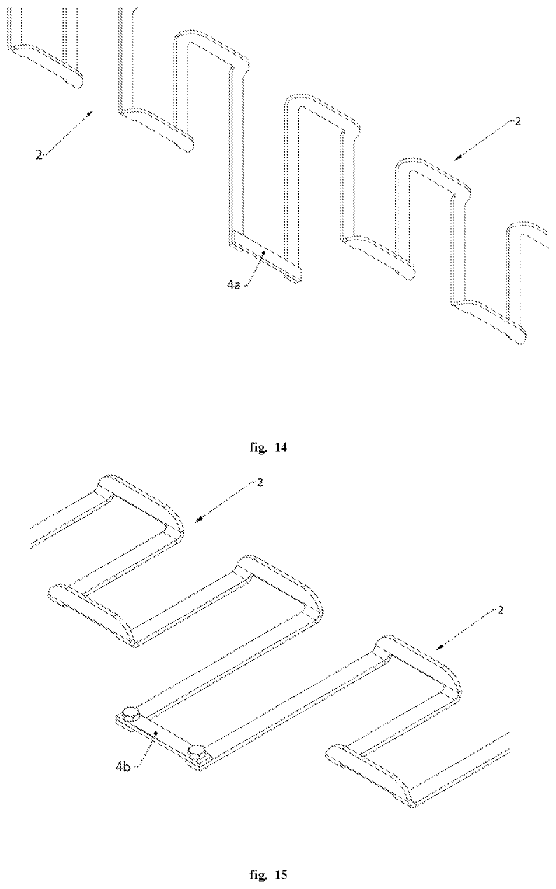

FIG. 14 shows the connection of adjacent sections 3 by means of welding 4a of the phase path endings.

FIG. 15 shows the connection of adjacent sections 3 by means of fastening with screws of the connector 4b to the ends of the phase paths.

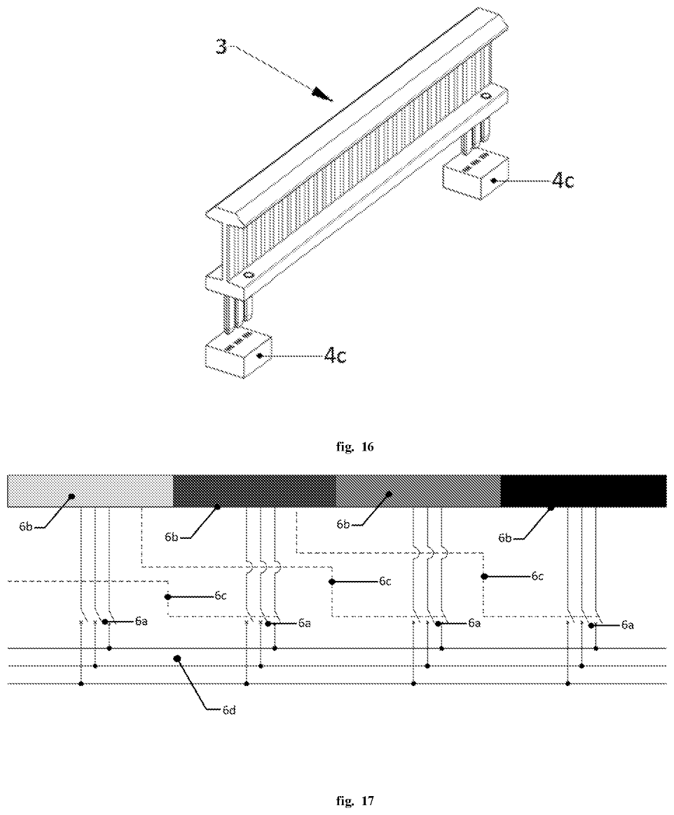

FIG. 16. shows a connecting socket 4c, enabling a three-phase winding 3a to be placed in it.

FIG. 17 shows a schematic system of track sectioning with contactors 6a, connecting the subsequent sections 6b with the three-phase mains 6d. The signal cable 6c is also marked, informing about the current vehicle position and about the switching sequence of particular sections.

### EMBODIMENT 1

The phase path 2 (FIG. 2) is made by bending of the flat bar 1 at a selected binding radius R₁ or by cutting from a metal sheet 5. The cutting is done with laser beam, water, plasma or by die shearing. The shape of this element 2 is cyclically repeated with each subsequent pole pitch τ. At this stage, the active part 2a and the end parts 2b make a uniform plane, where the phase path has any length L. The production limitations include, for example, the dimensions of available material or the working area of the bending or cutting machine tool. The single phase path has elongated end fragments: the beginning of section 2c and the end of section 2d. They enable the mutual connection of subsequent sections. Then, such an element is bent along the line which separates the end part from the active part. The phase path is bent at the bending radius R₂, as shown in FIG. 4. If the bending radius exceeds 0 m, then the active part and the end parts cease to form a common plane and the angle α₁ appears in the range from 0 to 180°. Each of the phase paths is bent at various heights, what enables to lay them out in a non-conflicting way into a three-phase winding 3a, what is shown in FIG. 6. Each phase path is bent at a different bending angle α₁ or it has a different height of the active part. It allows all the construction variants to be laid out in a non-conflicting way into a three-phase winding 3a, as in FIG. 6. One example of the application of such a winding is a double-sided, synchronous, linear motor, the windings of which can be composed of two three-phase windings, laid out side-by-side, as in FIG. 7, with a thin separator 3c in between. The angle α₁ may be the same for each phase, as shown in FIG. 6, where it is 90°, it may, however, also be variable, as in FIG. 10, where the angle α₁ is 0°, 30° and 60°, respectively. Such a laid out winding is covered with an insulation layer, either by lacquer coating or pouring with a thermoplastic material 3d in a preset mould. The thermoplastic material is used to pour onto end parts and the active part, however, pouring does not include the terminals from the beginning of the section 3e or the terminals from the end of section 3f, as shown in FIG. 8. At this stage, a self supporting structure of the single winding section 3 is formed, the structure being fastened to the base. The fastening is made by means of screws 3b (FIG. 9), spring latches 3i (FIG. 13) or spring clips 3h (FIG. 12). The complete winding of a linear motor is made by connection with subsequent sections. The connections between subsequent sections are made by means of contactors 4b, fastened with screws (FIG. 15) to the terminals from the end of one section and to the terminals from the end of a subsequent section or by welding of the terminals from two adjacent sections 4a (FIG. 14) or by placing the terminals from the end and from the beginning of the adjacent section in a connection socket 4c (FIG. 16). One of the ways to connect sections is the use of a contactor system 6a (FIG. 17), enabling an infinitely variable sectioning of a track during a vehicle passage, and thus allowing for reduction of the length of a powered section. The subsequent sections 6b are activated only when the vehicle runs either on them or on their adjacent sections. This information is delivered to the contactors by the signal cable 6c. The contactors switch on subsequent phases, connecting them with the three-phase mains 6d. In this way, the losses, associated with the energy transfer in the track, will be reduced

### EMBODIMENT 2

This exemplary embodiment shows a winding, the phase path of which is presented in FIG. 2 and FIG. 5 and which has the following dimensions:

The phase path length L=920 mm,
The pole pitch τ=10 mm,
The height of the active part=15 mm,
The height of the end part=6 mm,
The radius R₁=6 mm,
The radius R₂=6 mm,
The bend angle α₁=90°.

The proposed solution enables to reduce the production costs of a linear motor winding in case, when it is laid out on a route of many kilometres. The method according to the invention consists in using easily available materials, such as flat bars and metal sheets. Another specific feature, resulting in a lower production cost, are the simple and fast procedures of material processing, i.e. sheet cutting or flat bar bending. These two mentioned features mean that a winding, made in such a way, is cheaper than an analogous one, made of conductors or cut from a sheet to be then welded or press welded. Due the process of pouring a thermoplastic material onto the winding, a self-supporting structure is obtained, which is easy in transport, handling and assembly.

Another advantage of the proposed solution is its universality. First of all, taking into account the type of the used drive system. The winding of a linear motor in various geometric configurations is intended for application both in induction and synchronous motors, where it supports a mover mounted on a vehicle. It is possible to construct a motor in a single-sided and double-sided system. Various selection values of the angle α₁ enable to control the height of the entire stator, what influences the shape of the vehicle chassis.

The use of a solid, coreless winding enables to reduce the production costs and eliminate the negative effects, observed in linear machines, such as the cogging force. The form, in which the winding is proposed, i.e. ready-made sections of a predefined length, allows for a fast and cheap assembly on a previously prepared base.

The solution, according to this invention, is used as an element of an electric linear motor driving the vehicle. The solution is used in high-speed transport applications, at environments with atmospheric or decreased air pressure.

1. The method of construction of a linear motor winding, consisting of phase paths, characterised in that a solid flat bar is cyclically bent at a selected binding radius, an active part and an end part make a uniform plane of the phase path, which has got elongated end fragments: a beginning of a section and an end of the section or the phase path is cut of a metal sheet, and then, it is bent along the line, separating the end part from the active part the phase path is bent at the bending radius, where the bend angle α1 is within the range between 0° and 180°.

2. The method of claim 1, characterised in that a solid flat bar or sheet is made of a diamagnetic or paramagnetic material.

3. The method of claim 1, characterised in that the phase paths are laid down parallel and in a non-conflicting way, making a section.

4. The method of claim 3, characterised in that the winding of a linear winding is sectioned and consists of many identical sections.

5. The method of claim 3, characterised in that subsequent sections are connected by means of screws and then placed in clamping plugs, welded or connected via a system of contactors.

6. The method of claim 1, characterised in that the phase path is cut from a metal sheet with laser beam, water or plasma.

7. The method of claim 1, characterised in that the winding is made as either single- or double-layer winding.

8. The method of claim 1, characterised in that the active part and the end parts are covered with an insulation layer, either by lacquer coating or by pouring a thermoplastic material on it in a prepared mould.

9. The method of claim 1, characterised in that the sections are fastened to a base with screws, spring clips or latches.
